(19) United States
(12) Patent Application Publication
(10) Pub. No.: US 2008/0283506 A1
(43) Pub. Date: Nov. 20, 2008

(54) System For Joining Nuts to Workpieces and Loading Device For Such a System

(76) Inventor: Heiko Schmidt, Regensburg (DE)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 11/661,356

(22) PCT Filed: Aug. 22, 2005
(86) PCT No.: PCT/DE05/01470

§ 371 Date: Jun. 25, 2008

(30) Foreign Application Priority Data
Sep. 2, 2004 (DE) 102004042970.7

(51) Int. Cl. B23K 11/00

(52) U.S. Cl. 219/79

(57) ABSTRACT

The invention relates to a novel system for inserting or mounting nuts in workpieces by means of welding. Said system comprises a welding station to which the nuts are fed via a conveying section.

### BACKGROUND OF THE INVENTION

The invention relates to a system for joining nuts to workpieces and to a loading device for use in such a system.

It is an object of the invention is to present a system that enables the particularly reliable joining of weld-on nuts to workpieces by means of welding.

### SUMMARY OF THE INVENTION

In the system according to the invention the respective weld-on nuts are transported from a supply unit via a flexible external guide to the loading device, preferably by means of injection with compressed air. From a loading position of the loading device, one nut at a time is then moved via the loading channel of said device to the welding station, where the nut is joined to the workpiece by means of welding (resistance welding).

### BRIEF DESCRIPTION OF THE DRAWINGS

The invention is described in more detail below based on an exemplary embodiment with reference to the drawings, in which:

FIG. 1 shows a simplified depiction in side view of a loading device for feeding weld-on nuts to a welding station; and

FIG. 2 shows the device in top view.

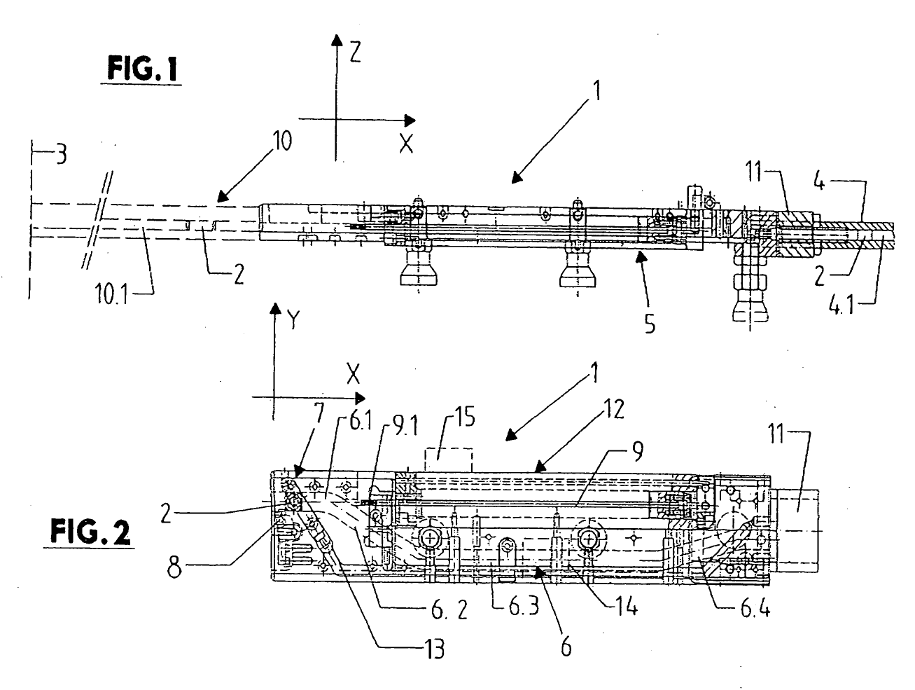

### DETAILED DESCRIPTION OF THE INVENTION

For the sake of clarity, the perpendicularly oriented spatial axes are indicated in the drawings as the X-axis, Y-axis and Z-axis.

The loading device generally designated 1 in the drawings is used to feed connecting elements, especially weld-on nuts 2 to a welding station 3, in which said nuts are joined to a workpiece, for example a sheet metal element, by means of electric arc welding (resistance welding). The nuts 2 are fed to the device 1 by a supply unit not depicted via a supply hose 4 by means of injection with compressed air, during which the nuts 2 are already oriented correctly in the supply hose.

The device 1 itself consists essentially of a housing 5, which in the depicted embodiment is elongated and rectangular in shape when viewed from above and is oriented with its longitudinal axis in the X-axis, with its width in the Y-axis and with its thickness in the Z-axis. In the housing 5 there is a guide channel 6, which is connected at one end to the supply hose 4 or to the channel 4.1 formed in this supply hose and in which the nuts 2 are oriented with their axis or with the axis of their nut threads in the direction of the Z-axis and therefore perpendicular to the top and bottom sides of the flat housing 5 lying in the XY-plane.

At the other end of the housing 5 the guide channel 6 forms at one channel section 6.1 a loading position 7, which is used for the reception of one respective nut 2. At the loading position 7 at least one spring-mounted catch 8 is provided, which initially stops or retains the respective nut 2 injected via the supply hose 4 and the guide channel 6 at the loading position 7. By means of a slider 9 or slider surface 9.1 that can move in the direction of the X-axis, the respective nut 2 waiting at the loading position 7 is then pushed by overpressing the catch 8 into the relatively long loading channel 10.1 formed by a rigid guide 10, which (loading channel) adjoins the loading position 7 and the cross-section of which is adapted to the shape of the nuts 2 and moves to the welding station 3 by pushing further.

The loading channel 10.1 has a length that is a multiple of twice the diameter of one nut 2. Since only one nut 2 is fed via the guide 10 to the welding station 3 with each forward movement of the slider 9, the forward stroke of the slider 9 is likewise a multiple of twice the diameter of one nut 2.

As depicted in FIG. 2, the loading position 7 with the catch 8 is located on the channel section 6.1 extending in the direction of the X-axis. In order to inject the nuts 2 to the loading position 7, past the slider 9 positioned in its retracted starting position or the slider end 9.1 positioned in its starting position, the guide channel 6 forms one channel section 6.2 which leads laterally and diagonally into the section 6.1, so that the section 6.2 forms with the X-axis an angle smaller than 90°, which opens toward the ends of the guide channel 6 connected with the supply hose 4.

One channel section 6.3 leads into the channel section 6.2, the former lying with its longitudinal extension in the direction of the X-axis and into which one channel section 6.4 extending diagonally to the X-axis leads, the latter section being connected with the supply hose 4 by means of a connection 11.

The slider 9 in the depicted embodiment is the piston rod, oriented with its longitudinal axis in the X-axis, of a piston-cylinder array 12, which is provided in a recess of the housing 5. When the slider 9 is in its starting position it is almost entirely within the cylinder piston-cylinder array. The course of the guide channel 6 formed by the channel sections 6.2, 6.3 and 6.4 makes it possible to accommodate both the guide channel 6 and the piston-cylinder array 12 in the flat housing 5, with a very small and compact design. The axes of the channel sections 6.1-6.4 are congruent with the axes of the loading channel 10 and the longitudinal axis of the slider 9 in a common XY-plane.

A sensor 13 for monitoring the presence of a weld-on nut 2 is provided at the loading position 7.

In the depicted embodiment, one nut 2 is injected in each cycle via the supply hose 4 and the guide channel 6 to the loading position 7 and then pushed by the actuation of the piston-cylinder array 12 with the slider 9 from the loading position via the guide 10 into the welding station 3.

In order to shorten the cycle time, it is also possible to provide, by means of injection, a supply of several nuts 2 in the guide channel 6, for example in the channel section 3, and then to transport one nut 2 respectively in each cycle via the channel section 6.2 to the loading position 7. For this purpose, a device with a sluice function is provided for example at the channel section 6.3, as generally indicated by 14 in FIG. 2. This device 14 is designed so that when the slider 9 is retracted to its starting position, one nut 2 is moved respectively via the channel section 12 into the loading position, for example by means of an air current, which is generated by a corresponding nozzle of the device 14.

Since the transition area between the channel sections 6.2 and 6.1 is blocked for the nuts 2 by the slider 9 when moved forward, it is also possible to place the next respective nut 2 into a preparatory position in the channel section 6.2 and laterally bearing against the slider 9, before the slider is moved back to its starting position. This can likewise reduce the cycle time considerably.

One special feature of the device 1 is that in each cycle one nut 2 is moved respectively from the loading position 7 over the entire length of the guide 10 to the welding station 3. The guide 10 has a length that is significantly greater than twice the diameter of the nuts 2, so that the functional elements of the device 1, particularly also the piston-cylinder array 12, the sensor 13 and the catch 8 are at a sufficient distance from the welding station 3, thus reliably preventing interference from the welding station. The guide 10 is made of a non-ferromagnetic material, for example of an insulating material, for example of a suitable synthetic material or ceramic.

In the depicted embodiment the piston-cylinder unit 12 is designed so that the respective nut 2 is moved from the loading position 7 along the loading channel 10.1 against a stop formed in the welding station 3. If during a movement stroke of the slider 9 no nut 2 is moved with the slider 9 or its slider surface 9.1 into the welding station 3, this will result in a somewhat larger movement stroke for the slider 9 than when moving a nut 2. Therefore, a further sensor monitors the end position of the slider 9 and also the proper feeding of the nuts 2 from the loading position 7 to the welding station 3.

The invention was described above based on one sample embodiment. It goes without saying that modifications and variations are possible without abandoning the underlying inventive idea upon which the invention is based.

### REFERENCE LIST

1 device
2 weld-on nut
3 welding station
4 supply hose
4.1 channel in supply hose
5 housing
6 guide channel
6.1, 6.2, 6.3, 6.4 channel section
7 loading position
8 catch
9 slider
10 guide
10.1 guide channel
11 connection
12 piston-cylinder array
13 sensor
14 device with sluice function

What is claimed is:

1. A system for joining or mounting nuts in workpieces by means of welding with a welding station, to which the nuts are fed via a conveyor or feeding line, wherein a device for loading the welding station with one nut respectively in each cycle is provided in the conveyor line before the welding station.

2. The system according to claim 1, wherein the loading device between the welding device and a loading position forms a loading channel and comprises a slider with a slider surface, with which the respective nut positioned at the loading position is moved from the loading position to the welding station during actuation of the slider.

3. The system according to claim 2, wherein the slider surface is formed by one end of the slider.

4. The system according to claim 2, further comprising a channel formed in the device or in a housing of the device for feeding the nuts to the loading position.

5. The system according to claim 4, wherein the channel leads into the loading position or a channel section forming said loading position at an angle in relation to the axis of the loading channel and/or the axis of the movement of the slider.

6. The system according to claim 2, wherein the slider is located in a starting position with its slider surface outside of the feed channel.

7. The system according to claim 2, wherein the slider or its slider surface can be moved into the feed channel for the forward movement of a nut waiting at the loading station via the loading channel to the welding station.

8. The system according to claim 2, wherein the slider or its slider surface can be moved at least in one second axis (Y-axis, Z-axis) extending perpendicular to the first axis (X-axis).

9. The system according to claim 2, wherein the slider is formed at least on a partial length by a piston rod of a piston-cylinder unit.

10. The system according to claim 2, wherein the loading channel and/or the slider are made of an electrically non-conductive material.

11. The system according to claim 2, wherein the loading channel and/or the slider are made of a non-magnetizable material or stainless steel.

12. The system according to claim 2, further comprising at least one sensor at the loading position.

13. The system according to claim 2, further comprising at least one sensor for determining at least one end position of the slider.

14. The system according to claim 4, wherein the housing is a flat, rectangular housing.

15. The system according to claim 4, further comprising means for separating the nuts are provided in the feed channel.

16. The system according to claim 4, wherein the feed channel is connected via an outer, preferably flexible guide to a supply unit for the nuts.

17. A loading device for a system for joining or mounting nuts in workpieces by welding, with a welding station, to which the nuts are fed via a conveyor line, wherein the loading device between the welding device and the loading position forms a loading channel and features a slider with a slider surface, with which the respective nut positioned at the loading position is moved from the loading position to the welding station during actuation of the slider.

18. The loading device according to claim 17, wherein the slider surface is formed by one end of the slider.

19. The loading device according to claim 17 further comprising a channel formed in the device or in a housing of the device for feeding the nuts to the loading position.

20. The loading device according to claim 19, wherein the channel leads into the loading position or a channel section forming said loading position at an angle in relation to the axis of the loading channel and/or the axis of the movement of the slider.

21. The loading device according to claim 17, wherein the slider is located in a starting position with its slider surface outside of the feed channel.

22. The loading device according to claim 17, wherein the slider or its slider surface can be moved into the feed channel for the forward movement of a nut waiting at the loading station via the loading channel to the welding station.

23. The loading device according to claim 17, wherein the slider or its slider surface can be moved at least in one second axis (Y-axis, Z-axis) extending perpendicular to the first axis (X-axis).

24. The loading device according to the slider is formed at least on a partial length by a piston rod of a piston-cylinder unit.

25. The loading device according to claim 17, wherein the loading guide and/or the slider are made of an electrically non-conductive material.

26. The loading device according to claim 17, wherein the loading guide and/or the slider are made of a non-magnetizable material or stainless steel.

27. The loading device according to claim 17, further comprising at least one sensor at the loading position.

28. The loading device according to claim 17, further comprising at least one sensor for determining at least one end position of the slider.

29. The loading device according to claim 19, wherein the housing is a flat, rectangular housing.

30. The loading device according to claim 19, further comprising means for separating the nuts are provided in the feed channel.

31. The loading device according to claim 19, wherein the feed channel is connected via an outer, flexible guide to a supply unit for the nuts.
